(19) United States
(12) Patent Application Publication
(10) Pub. No.: US 2010/0050469 A1
(43) Pub. Date: Mar. 4, 2010

(54) MULTI-FUNCTION HEALTH CARE SELF-CLEANING SHOE MATERIAL

(75) Inventor: Hung-Jen Chen, Taichung County (TW)

Correspondence Address: ROSENBERG, KLEIN & LEE, 3458 ELLICOTT CENTER DRIVE-SUITE 101, ELLICOTT CITY, MD, 21043, US

(73) Assignee: U-BOND INC., Apia (WS)

(21) Appl. No.: 12/449,891

(22) PCT Filed: Mar. 11, 2008
(86) PCT No.: PCT/CN2008/070464

§ 371 Date: Sep. 2, 2009

(30) Foreign Application Priority Data
Mar. 12, 2007 (CN) 200720103806.9

(51) Int. Cl. A43B 3/10; B32B 3/02; B32B 3/12; B32B 37/00; A43B 19/00; A43B 13/00

(52) U.S. Cl. 36/10; 428/193; 428/116; 156/73.2; 36/71; 36/25 R; 977/773

(57) ABSTRACT

A kind of multi-function health care self-cleaning shoe material comprises a shoe material main body (10). The shoe material main body (10) has a peripheral contour area (11), an inner area (12) and at least a sheet-form web body (120), which is located in the inner area (12) of the main body (10). The web body (120) is fixed on the peripheral contour area (11). The web body (120) is a web-form braid having plural fibers in warp direction (12) and plural fibers in weft direction (13). Many functional particles (130) are contained in the fibers.

### FIELD OF THE INVENTION

The present invention relates to a multi-function health care self-cleaning shoe material, which can be used for shoe vamp, shoe pad, or shoe sole.

### BACKGROUND OF THE INVENTION

Shoes are necessaries for human daily life and are used for most of the time. Wearing shoes for such a long time may significantly influence human health. Specifically, the air permeability and antibacterial ability for shoes are quite important. The shoe sole, shoe vamp, and shoe pad are the components of a conventional shoe. Once these components are designed to have air permeability and antibacterial ability, it would increase the shoes' function in ensuring the health of the shoe wearers. To the inventor's knowledge, the conventional shoe material with antibacterial ability is only used for shoe pad, but not for shoe vamp and shoe sole. The conventional shoe pad with antibacterial ability is manufactured from nonwoven cloth (fabric) and an antibacterial material is added into the nonwoven cloth, making insufficient air permeability, uncomfortable to wear, unable to reuse in a long term through simple cleaning process, bad durability, and unable to produce effective vibration in the shoe pad such that the functional material thereof cannot exhibit its effect in the foot environment.

### SUMMARY OF THE INVENTION

The first objective of the present invention is to provide a multi-function health care self-cleaning shoe material with better air permeability and air cushion structure. Further, through the friction, vibration, air flow, temperature difference between the foot and the fibers, nano functional particles react to achieve the effects of sufficiently effective bacteria-killing, anti-bacteria, mildewproof, anti-mite, negative ion, far-infrared ray, flameproof, antistatic, anti-electromagnetic wave, deodorization, TVOCs elimination, and so on.

The second objective of the present invention is to provide a multi-function health care self-cleaning shoe material with everlasting fragrance for preserving human health.

The third objective of the present invention is to provide a manufacturing method for a multi-function health care self-cleaning shoe material.

In order to achieve the above objectives, the present invention introduces the following scheme.

The present invention has the following advantageous effect:
1. The multi-function health care self-cleaning shoe material of the present invention uses polypropylene or polyethylene fragments mixed with functional particles (for example, tourmaline, nano silver particle, ferment, microcapsule, and so on), mixing, fusing, and spinning to produce fibers. The fibers are used to produce a web body and then designed to produce a shoe material, for example, shoe pad, shoe sole, or shoe vamp with better air permeability and air cushion structure. Through the friction, vibration, air flow, temperature difference between the foot and the fibers, nano functional particles react to achieve the effects of sufficiently effective bacterial killing, anti-bacteria, mildewproof, anti-mite, negative ion, far-infrared ray, flameproof, antistatic, anti-electromagnetic wave, deodorization, TVOCs elimination, pollutant PMx elimination, and so on.
2. The multi-function health care self-cleaning shoe material of the present invention uses polypropylene or polyethylene fragments mixed with functional particles (for example, tourmaline, nano silver particle, ferment, microcapsule, and so on), mixing, fusing, and spinning to produce fibers, and uses TPE to control the release of micro capsules and enhance the elasticity and comfortability. Micro capsules containing natural essential oil are included in the fibers to make the shoe material with everlasting fragrance for preserving human health.

### BRIEF DESCRIPTION OF DRAWINGS

FIG. 1 shows a perspective view of a shoe pad made from the shoe material of the present invention in association with a shoe.

FIG. 2 shows a plane view of a shoe pad made from the shoe material of the present invention.

FIG. 3 shows a shoe vamp made from the shoe material of the present invention.

FIG. 4 shows a partial sectional view of a fiber of the shoe material of an exemplary embodiment of the present invention.

FIG. 5 shows a shoe material of another exemplary embodiment of the present invention.

FIG. 6 shows a shoe material provided with a cloth layer of an exemplary embodiment of the present invention.

FIG. 7 shows a slipper formed by a shoe sole of an exemplary embodiment of the present invention.

FIG. 8 shows a web body with three dimensional honeycomb structure of an exemplary embodiment of the present invention.

FIG. 9 shows an enlarged view of the three dimensional honeycomb structure unit of the present invention.

FIG. 10 shows a side view of FIG. 8.

FIG. 11 shows a top mold and a first bottom mold of an exemplary embodiment of the present invention.

FIG. 12 shows a forming process with the top mold and the first bottom mold of an exemplary embodiment of the present invention in closed state.

FIG. 13 shows a top mold and a second bottom mold of an exemplary embodiment of the present invention.

FIG. 14 shows a forming process with the top mold and the second bottom mold of an exemplary embodiment of the present invention in closed state.

### DETAILED DESCRIPTION OF SPECIFIC EMBODIMENTS

The following exemplary examples will be described in detail with the appended drawings in order to make the objectives and means of the present invention more clearly understood.

### I. Basic Structure of the Shoe Material of the Present Invention

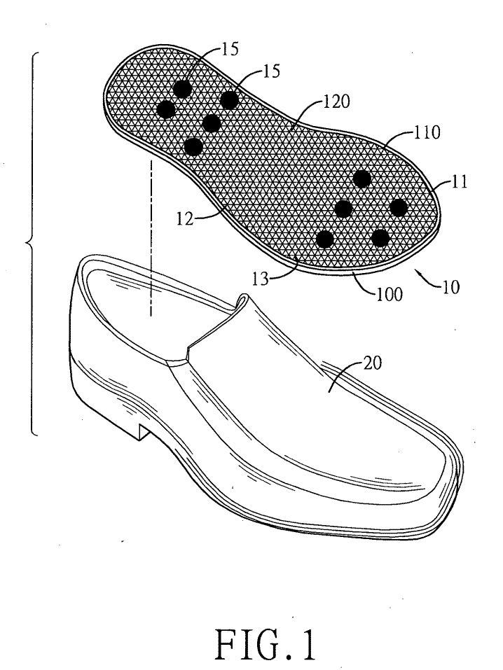

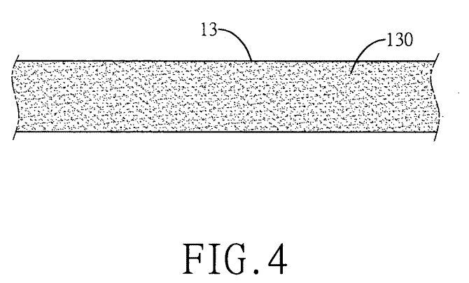

Referring to FIG. 1, a main objective of the present invention is to design a multi-function health care self-cleaning shoe material. The shoe material can be shoe vamp, shoe pad or shoe sole. The basic structure includes a shoe material main body 10 having a peripheral contour area 11 and an inner area 12 and a sheet-form web body 120 provided in the inner area 12 of the shoe material main body 10. The web body 120 is fixed on the peripheral contour area 11. The web body 120 is a web-form fabric having plural fibers 13 in warp direction and plural fibers 13 in weft direction, and there are a plurality of functional particles 130 (referring to FIG. 4) in the fibers. The fiber is between 50 and 10000 Denier. The fiber can be made of polypropylene, polyethylene, nylon, tetolon, and so on, depending on the required characteristics; for example, polypropylene is acid proof and alkali proof.

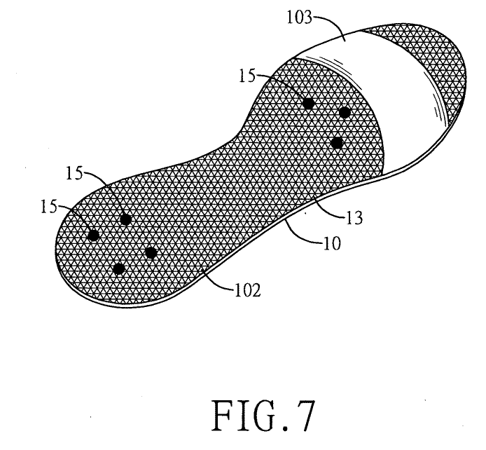

Referring to FIGS. 1 and 7, if the shoe material is used for shoe pad 100 or shoe sole 102, in order to enhance the strength of the shoe pad 100 or shoe sole 102, a plurality of reinforcements 15 may be provided on certain locations of the shoe pad 100 or the shoe sole 102 to enhance the support and elastic abilities of the shoe pad 100 or the shoe sole 102. The reinforcements 15 may be made of polyurethane (PU), thermoplastic elastomer (TPE) or EPA for good durability. The reinforcements 15 may be formed on the shoe pad 100 or the shoe sole 102 by directly pouring PU, TPE, or EPA to the shoe pad 100 or the shoe sole 102, followed by a drying process.

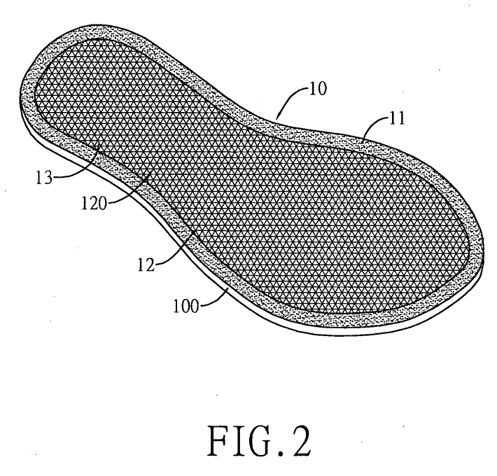

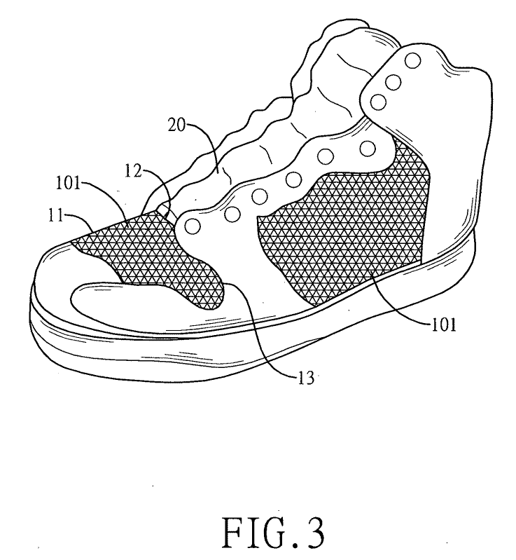

The shoe material main body 10 of the present invention may be a shoe sole 102 (FIG. 7) or shoe pad 100 (FIGS. 1 and 2), or a shoe vamp 101 (FIG. 3). The shoe pad 100 is placed in the shoe 20 to separate the shoe sole and the human foot so as to generate air cushion effect and prevent the shoe sole from being rapidly worn away. When the shoe material main body 10 is used for shoe pad 100, the shoe pad 100 includes the peripheral contour area 11, the inner area 12 and the web body 120, wherein the peripheral contour area 11 of the shoe pad 100 may be a glue layer used to fix the ends of the fibers 13. Further, the peripheral contour area 11 of the shoe pad 100 may also be a bonding line 110 formed by fusing the fibers 13 of the web body 120 together with the ends of the fiber 13 being fixed by the bonding line 110.

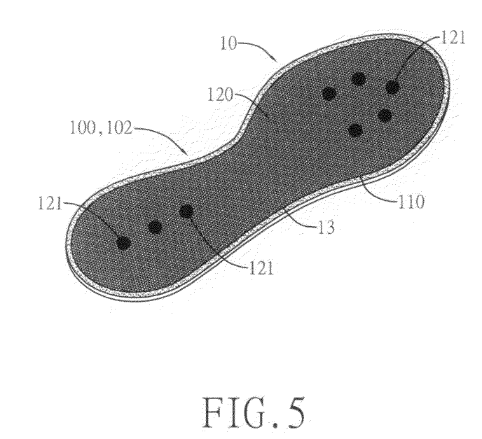

Furthermore, referring to FIGS. 5 and 7, in the case that the shoe material main body 10 is used for shoe sole 102 or shoe pad 100, it may include a plurality of layers of the web body 120 to increase the thickness of the inner area 12 and in turn to enhance air permeability and air cushion effect. Each layer of the web body 120 includes plural fibers 13 in warp direction and plural fibers 13 in weft direction. The peripheral contour area 11 of each layer of the web body 120 is a bonding line 110 formed by fusing fibers 13 themselves together with the ends of the fibers 13 being fixed by the bonding line 110. As shown in FIG. 5, according to a preferred embodiment of the present invention, the inner area 12 includes at least one dot-shaped or line segment-shaped bonding portion 121. The bonding portion 121 is formed by bonding the fibers 13 of the web body 120 themselves together and can enhance the robustness of the web body 120 when stacking.

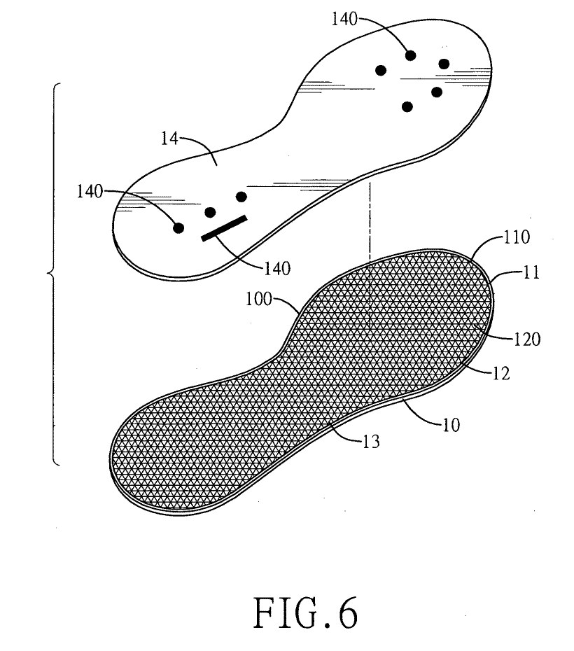

Referring to FIG. 6, the shoe material main body 10 is used for shoe pad 100. A cloth layer 14 is further provided. The cloth layer 14 overlies the web body 120 of the shoe pad 100, and the friction coefficient of the cloth layer 14 is higher than the friction coefficient of the web body 120. In a preferred embodiment, the cloth layer 14 and the web body 120 of the shoe pad 100 are bonded together by at least one dot-shaped or line segment-shaped bonding portion 140 so as to enhance the robustness between the web body 120 and the cloth layer 14.

Referring to FIG. 7, in the case that the shoe material main body 10 is used for shoe sole 102, an arc-shaped belt 103 is connected to the shoe sole 102 for human's foot to wear in so as to form a slipper structure.

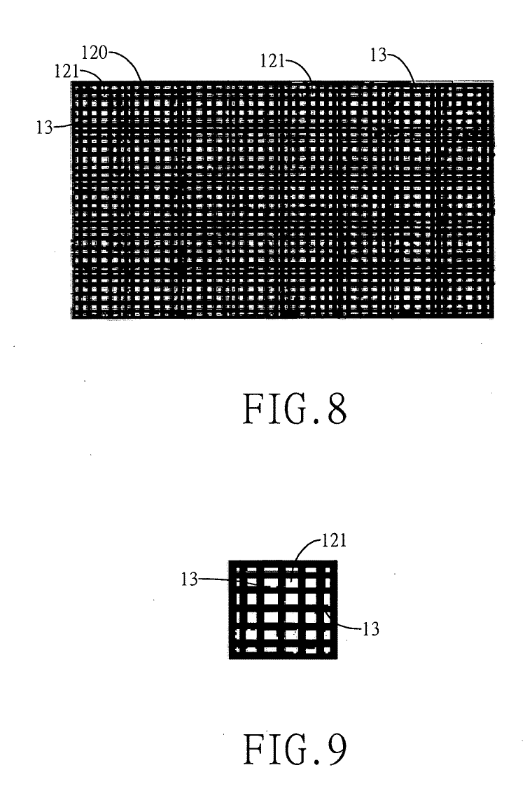

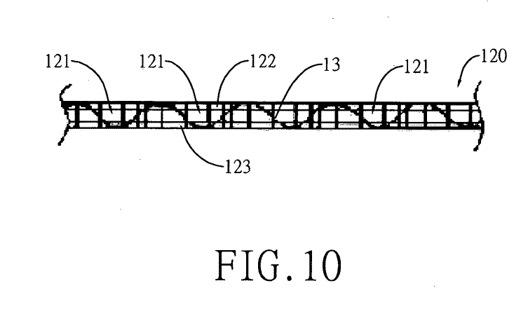

Referring to FIGS. 8 to 10, the web body 120 of the shoe material main body is weaved to have an array of a plurality of three dimensional honeycomb structure 121. Each honeycomb structure 121 is formed by plural warp fibers 13 arranged along a first arc face 122 and plural weft fibers 13 arranged along a second arc face 123. The first arc face 122 intersects the second arc face 123. With the three dimensional honeycomb structure 121, high structure strength and air cushion effects of the shoe material are achieved.

In a preferred embodiment, the functional particles may be submicron tourmaline to make the shoe material have the effects of generating negative ion, far-infrared ray, self-clean, deodorization, antistatic, anti-electromagnetic wave, and so on, and one of the following micro particle healthy factors can be added: nano bamboo carbon, zinc oxide, cupric oxide, ferric oxide, silica, tungsten oxide, manganese oxide, cobalt oxide, nickel oxide.

In another preferred embodiment, the functional particles may be nano silver particle to make the shoe material have the effects of bacterial killing, anti-bacteria, mildewproof, anti-mite, and so on, and one of the following healthy micro particle factors for killing bacterial, anti-bacteria, and mildewproof can be added: chitin, ferment, or nano noble metal, e.g., copper, zinc, aurum, platinum, palladium, and niobium.

In another preferred embodiment, the functional particles may be microcapsule provided with an internal storage space for storing various functional materials. The microcapsule is made of chitosan, thermoplastic elastomer, and so on. The functional material may be natural essential oil selected from the group consisting of lavender, lemon, hinoki, rosemary, eucalyptus, tea tree, sandalwood, bergamot, pine, jasmine, rose, chamomile, Ylang Ylang, basil, geranium, niaouli, cardamom, musk, myrrh, cinnamon, fennel, frankincense, citrus, peppermint, cedarwood, patchouli, palmarosa, clove, grapefruit, benzoin, ginger, citronella, and marjoram.

By combining the above functional micro particle materials and the structure characteristics of the materials, a multi-function health care self-cleaning shoe material is invented. Different functions and structures of the shoe material may be designed based on different requirements.

### II. Manufacturing Method of the Shoe Material of the Present Invention

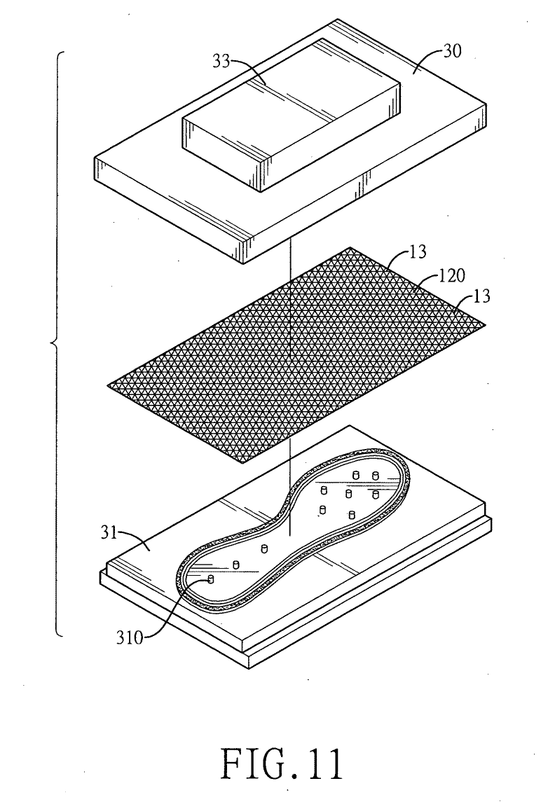

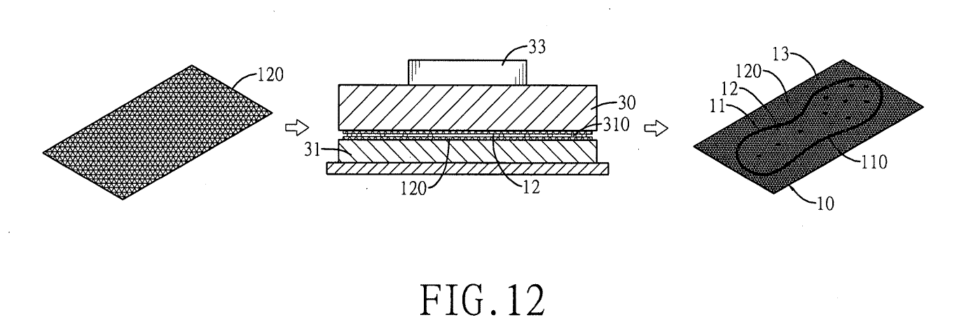

Referring to FIG. 11, a method for manufacturing a shoe material of the present invention includes providing at least one sheet-form web body 120, the web body 120 being a web-form fabric having plural fibers 13 in warp direction and plural fibers 13 in weft direction, and there being a plurality of functional particles 130 in the fiber 13 (FIG. 4); forming at least one bonding line 110 (FIG. 12) on the web body 120 by bonding the fibers 13 together through an ultrasonic processing, the bonding line 110 being a peripheral contour area 11 which defines an inner area 12 from the web body 120, the inner area 12 defining the shape of the shoe material main body 10.

Referring to FIGS. 11 and 12, in a preferred embodiment, an ultrasonic method includes using an ultrasonic wave generation device 33, a top mold 30, and a first bottom mold 31; placing at least one web body 120 between the top mold 30 and the first bottom mold 31; closing the top mold 30 and the first bottom mold 31; causing the top mold 30 to have ultrasonic vibration using the ultrasonic wave generation device 33 so as to form at least one bonding line 110 on the web body 120 as a result of bonding the fibers 13, the bonding line 110 serving as a peripheral contour area 11 delimiting at least an inner area 12 from the at least one web body 120; and cutting along the bonding line 110 by a trimming method to complete the production of the shoe material.

Referring to FIGS. 5 and 11, in another preferred embodiment, the first bottom mold 31 is further provided with at least one dot-shaped or line segment-shaped bump 310. The at least one web body 120 comprises a plurality of web bodies 120 laminated together. With the bumps 310, dot-shaped or line segment-shaped bonding portions 121 are formed in the inner area 12 of the plurality of web bodies 120. The bonding portions 121 are formed by bonding the fibers 13 of the plurality of web bodies 120.

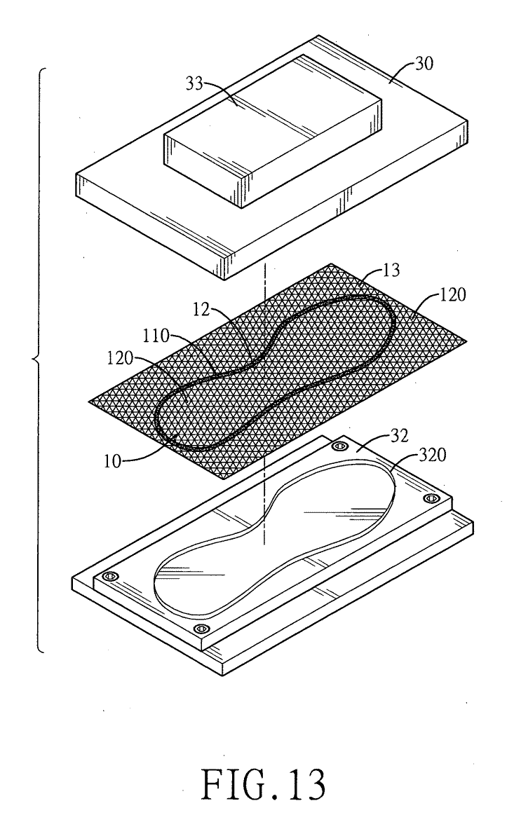

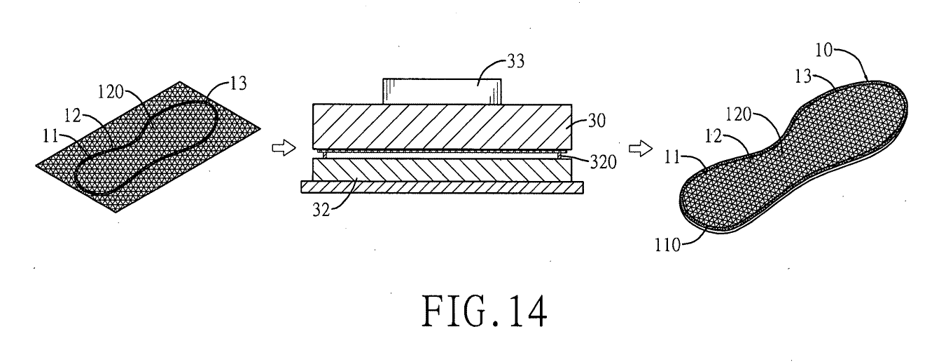

Referring to FIGS. 13 and 14, in another preferred embodiment, a second bottom mold 32 is further provided in the trimming method. The second bottom mold 32 is provided with a cutting edge 320 having similar outline of the bonding line 110. The method includes placing the web body 120 between the top mold 30 and the second bottom mold 32; closing the top mold 30 and the second bottom mold 32; causing the top mold 30 to have ultrasonic vibration using the ultrasonic wave generation device 33; and cutting along the bonding line 110 using the cutting edge 320 of the second bottom mold 32.

### III. Verification of the Functional Effects of the Shoe Material of the Present Invention

(i) Mechanical Test

TABLE 1
warpwise tensile strength result (kgf/cm²)

| | | 1% | 2% | | | |
|---|---|---|---|---|---|---|
| Test | No | tour- | tour- | 3% | 4% | 5% |
| times | additive | maline | maline | tourmaline | tourmaline | tourmaline |
| 1 | 38.704 | 36.075 | 36.005 | 37.085 | 36.251 | 36.215 |
| 2 | 39.483 | 36.108 | 38.068 | 38.251 | 37.511 | 38.014 |
| 3 | 44.581 | 40.652 | 37.065 | 39.125 | 38.253 | 37.588 |
| 4 | 42.015 | 40.206 | 40.126 | 36.001 | 35.921 | 37.263 |
| 5 | 41.076 | 38.254 | 36.008 | 35.759 | 38.205 | 36.952 |
| Average | 41.1718 | 38.259 | 37.4544 | 37.2442 | 37.2282 | 37.2064 |

As can be seen from the test result of Table 1, the tensile strength gradually decreases when the content of tourmaline increases, but it is still within the required strength.

(ii) Tensile Strength

TABLE 2
tensile strength (kgf/cm²)

| | | 1% | 2% | | | |
|---|---|---|---|---|---|---|
| Test | No | tour- | tour- | 3% | 4% | 5% |
| times | additive | maline | maline | tourmaline | tourmaline | tourmaline |
| 1 | 21.886 | 23.728 | 22.765 | 21.345 | 22.706 | 22.086 |
| 2 | 23.725 | 19.174 | 21.129 | 22.349 | 20.609 | 20.308 |
| 3 | 26.816 | 24.627 | 21.764 | 22.047 | 21.086 | 21.117 |
| 4 | 21.314 | 18.032 | 21.796 | 19.449 | 21.625 | 20.598 |
| 5 | 22.108 | 24.499 | 22.229 | 23.603 | 21.855 | 21.717 |
| Average | 23.1698 | 22.012 | 21.9366 | 21.7586 | 21.5762 | 21.1652 |

From the result of Table 2, the tensile strength of shoe material of the present invention decreases when the content of tourmaline increases. The tensile strength decreases about 5% when the content of tourmaline is 1%. The tensile strength decreases about 8.6% when the content of tourmaline is 5%. But it still has the required strength.

(iii) Washing Fastness

TABLE 3
washing fastness (Ion/cc)

| Negative ion | | Average after test | Decrease |
|---|---|---|---|
| amount | Before test | for five times | percentage of negative ion |
| 1% | 265 | 263 | 99% |
| 2% | 350 | 343 | 98% |
| 3% | 383 | 365 | 95% |
| 4% | 435 | 416 | 96% |
| 5% | 489 | 461 | 94% |

The test condition is 58% relative humidity and 29° C. The fastness is well maintained before and after test. The yield of negative ions does not decrease due to watering.

(iv) Far-Infrared Ray Performance

According to far-infrared ray and thermocouple tests, the shoe material of the present invention has far-infrared ray performance in a long term.

TABLE 4

| Measure temperature | 3-15 μm average radiant ray |
|---|---|
| 50° C. | 0.948 |

(v) Deodorization Performance

The follow table is obtained by applying JEM 1467 test method by GC-MS for testing the concentration of NH₃ and CH₃CHO and then testing the concentration of CH₃COOH. Based on Table 5, the shoe material of the present invention has deodorization ability.

TABLE 5
deodorization result by JEM 1467 test method

| Item | NH3 | NH3CHO | CH3COOH |
|---|---|---|---|
| The beginning concentration | 50.34 ng | 2.79 ng | 0.002PPMV |
| The concentration after 1 hour | 15.82 ng | 1.16 ng | 0.001PPMV |
| The removing rate of multi | 65.62% | 55.72% | 96.39% |
| pollution | | | |

(vi) Antibacterial Ability

TABLE 6

| | | Contaxt | |
|---|---|---|---|
| | Initial Inoculation | Time | Reduction (%) |
| Test item | (CFU/ml) | (1 hour later) | (1 hour later) |
| Staphylococcus aures | 1.0 × 10⁵ | 3.0 × 10⁴ | 99.9 |
| Escherichia coli | 2.1 × 10⁵ | 1.6 × 10³ | 99.9 |
| Klebsiella | 7.3 × 10⁵ | 3.0 × 10⁴ | 95.9 |
| pneumoniace | | | |

TABLE 7

| | GROWTH-FREE | Contact |
|---|---|---|
| Test item | ZONE | INHIBITION |
| Staphylococcus aures | 13.5 mm | 100% |
| Escherichia coli | 9.5 mm | 100% |
| Klebsiella pneumoniace | 15 mm | 100% |
| Staphylococcus aures | 12 mm | 100% |
| Escherichia coli | 4.5 mm | 100% |

From Table 6, the present invention has better antibacterial ability through ASTM E 2149-01 test method. From Table 7, the present invention also has better antibacterial ability through AATCC 147 test method.

(vii) Mildewproof Performance

TABLE 8

| | | Growth |
|---|---|---|
| Test item | test strains | condition |
| Mildewproof AATCC | Aspergillus niger ATCC6275 | 0 |
| 30 PART III | | |
| Mildewproof JIS Z 2911 | Aspergillus niger ATCC9642 | 0 |
| | Penicillium spp. ATCC9849 | 0 |
| | Chaetomium globosum ATCC6205 | 0 |
| | Myrothecium verrucaria TCC9095 | 0 |
| Mildewproof | Trichophyton mentagrophytes | 0 |
| ASTM G21-96 | TCC9533 | |

From Table 8, the present invention has better mildewproof performance according to AATCC 30 PART III, JIS Z 2911, and G21-96 tests.

(viii) Anti-Mite Performance

The shoe material of the present invention has better anti-mite performance as shown in Table 9 according to the repellent effect evaluation test of the Japanese Society of Industrial-Technology for Anti-mite.

TABLE 9

| | | Result | | | | |
|---|---|---|---|---|---|---|
| | | Test for 24 hours | | | | Repellent |
| Test item | | 1 | 2 | 3 | Average | rate (%) |
| Dermatophagoides | cotton | 963 | 1073 | 1137 | 1057.7 | 99.8% |
| pteronyssinus | Shoe | 0 | 0 | 6 | 2 | |
| | material | | | | | |

(ix) Fragrance Duration

As shown in Table 10, the present invention still has fragment effect after three months.

TABLE 10

| | | Result |
|---|---|---|
| | Result | (test after |
| Test item | (Initiation) | three months) |
| smell function | 3.4 | 4.0 |
| evaluation | | |

(x) Fragrance Components Analysis

The result of the following table is obtained by GC-MS test for the fiber of the shoe material with natural essential oil. As shown in Table 11, the shoe material of the present invention can efficiently achieve essential oil components cleaning ability.

TABLE 11

| | | Testing result | Testing limit | Testing result | Testing limit |
|---|---|---|---|---|---|
| Compound name | CAS number | (ug) | (ug) | (ug/g) | (ug/g) |
| Acetone | 000067-64-1 | 0.38 | 0.1 | 0.25 | 0.06 |
| 2-methylpentane | 000107-83-5 | 0.11 | 0.1 | 0.07 | 0.06 |
| 1,1-Dimethylallene | 000598-25-5 | 0.48 | 0.1 | 0.31 | 0.06 |
| 2,4-dimethylHexane | 000589-43-5 | 0.22 | 0.1 | 0.14 | 0.06 |
| 3,3-dimethylHexane | 000563-16-6 | 0.14 | 0.1 | 0.09 | 0.06 |
| 2,3-dimethylHexane | 000584-94-1 | 0.16 | 0.1 | 0.11 | 0.06 |
| 4-methylHeptane | 000589-53-7 | 0.12 | 0.1 | 0.07 | 0.06 |
| 2,4-Dimethylheptane | 002213-23-2 | 0.18 | 0.1 | 0.12 | 0.06 |
| 4-methylOctane | 002216-34-4 | 0.13 | 0.1 | 0.08 | 0.06 |
| PARA CYMENE | 000099-87-6 | 5.62 | 0.1 | 3.64 | 0.06 |
| .alpha.-pipene | 000080-56-8 | 36.74 | 0.1 | 23.78 | 0.06 |
| Fenchene | 000471-84-1 | 0.19 | 0.1 | 0.12 | 0.06 |
| Camphene | 000079-92-5 | 2.06 | 0.1 | 1.33 | 0.06 |
| SABINENE | 003387-41-5 | 21.76 | 0.1 | 14.09 | 0.06 |
| Pseudopinene | 000127-91-3 | 164.98 | 0.1 | 106.78 | 0.06 |
| n-Octanal | 000124-13-0 | 0.35 | 0.1 | 0.23 | 0.06 |
| p-Cymene | 000099-87-6 | 6.58 | 0.1 | 4.26 | 0.06 |
| LIMONENE | 000138-86-3 | 213.81 | 0.1 | 138.39 | 0.06 |
| Gamma-Terpinene | 000099-85-4 | 29.63 | 0.1 | 19.18 | 0.06 |
| Terpinolene | 000586-62-9 | 1.85 | 0.1 | 1.20 | 0.06 |
| D-3-carene | 013466-78-9 | 0.98 | 0.1 | 0.64 | 0.06 |
| Isopropenyltoluene | 026444-18-8 | 12.83 | 0.1 | 8.30 | 0.06 |

(xi) Indoor Air Quality

The result of the following table is obtained by JEM 1467 test method for elimination effect of indoor air quality (IAQ). As shown in Table 12, the present invention has effective cleaning ability for indoor air quality.

TABLE 12

| | Indoor air quality standard | | | | | | | | |
|---|---|---|---|---|---|---|---|---|---|
| | value | | | | | | | | Elimination |
| Indoor air quality | First class | | Second class | | Initial value | | Test result | | rate |
| CO₂ | 600 | ppm | 800 | ppm | 0 | hr | 1 | hr | 239 ppm/hr |
| | | | | | 2264 | ppm | 2025 | ppm | |
| HCHO | 0.1 ppm | | | | 0 | hr | 2 | hr | 0.5 ppm/hr |
| | | | | | 10 | PPM | 9 | ppm | |
| TVOCs | 3 ppm | | | | 0 | hr | 1 | hr | 48.11% |
| | | | | | 1800.42 | ng | 932.58 | ng | |
| Total bacterial population | 500 | CFU/M³ | 1000 | CFU/M³ | 0 | hr | 1 | hr | 63.2% |
| | | | | | 250 | CFU/M³ | 95 | CFU/M³ | |
| Suspension particle | 60 | ug/M³ | 100 | ug/M³ | 0 | hr | 20 | min | 99.9% |
| smaller than or equal to | | | | | 3.25 | | 0.01 | | |
| 10 um | | | | | | | | | |
| Suspension particle | 0.03 | ug/M³ | 0.05 | ug/M³ | 0 | hr | 15 | min | 99.9% |
| smaller than or equal to | | | | | 3.0 | | 0.01 | | |
| 2.5 um | | | | | | | | | |
| Ozone (O₃) | 0.03 | ppm | 0.05 | ppm | 0 | hr | 2 | hr | 100% |
| | | | | | 0.12 | ng | 0.00 | | |

(xii) Antistatic Performance

From Table 13, the shoe material of the present invention has better antistatic performance according to AATCC D4935-1999.

TABLE 13

| Test item | Test result |
|---|---|
| fabric surface resistance | >E+11 |
| (Ω/square) | |

(xiii) Anti-Electromagnetic Wave Performance

From Table 14, the shoe material of the present invention has better anti-electromagnetic wave performance according to AATCC 756-1995 (The test condition is 40% relative humidity and 20° C.).

TABLE 14

| Test item | | Test result |
|---|---|---|
| electromagnetic wave | 300 MHZ | 0.2 |
| blanking effect DB | | |
| electromagnetic wave | 1800 MHZ | 0.1 |
| blanking effect DB | | |

(xiv) Crushed Performance

From Table 15, the shoe material of the present invention has better crushed performance according to AHRAS 52.2 test of ASHRAE.

TABLE 15

| Measure rated | | | |
|---|---|---|---|
| flow percentage (%) | Flow (CFM) | Crushed (pa) | Crushed (in H₂O) |
| 50 | 600 | 0.4 | 0.001 |
| 75 | 900 | 0.7 | 0.003 |
| 100 | 1200 | 1.7 | 0.007 |
| 125 | 1500 | 3.4 | 0.014 |

(xv) Flameproof Performance

From Table 16, the shoe material of the present invention has better flameproof ability VTM-0 according to UL 94-97 method.

TABLE 16

| Test item | Sample 1 | Sample 2 | Sample 3 | Sample 4 | Sample 5 | VTM-0 |
|---|---|---|---|---|---|---|
| Sample thickness | 2.95 mm | 2.82 mm | 2.84 mm | 2.91 mm | 2.85 mm | |
| Remaining flame time of | 0 | 0 | 0 | 0 | 0 | ≦10 secs |
| each sample t1 (sec) | | | | | | |
| Remaining flame time of | 0 | 0 | 0 | 0 | 0 | ≦10 secs |
| each sample t2 (sec) | | | | | | |
| Total remaining flame | 0 | | | | | ≦50 secs |
| time of every five samples | | | | | | |
| (sum of t1 + t2 for five | | | | | | |
| samples) | | | | | | |
| Remaining flame time | 0 | 0 | 0 | 0 | 0 | ≦30 secs |
| plus remaining explosion | | | | | | |
| time after the second | | | | | | |
| ignition for each sample | | | | | | |
| t2 + t3 | | | | | | |
| Remaining flame or | no | no | no | no | no | no |
| remaining explosion burns | | | | | | |
| the clamping apparatus | | | | | | |
| Cotton is burned by | no | no | no | no | no | no |
| burned particle | | | | | | |

(xvi) RoHS Environmental Protection Performance

According to the result of the tested chemical substances (lead (Pb), cadmium (Cd), mercury (Hg), hexavalent chromium, polybrominated biphenyls, and polybrominated diphenyl ethers) from Tables 17 and 18, the shoe material of the present invention conform to the regulations of RoHS Directive 2002/95/EC.

TABLE 17

| | | | Method | | |
|---|---|---|---|---|---|
| | | | Detection | Result | RoHS |
| Test item(s) | unit | Test method | Limit | NO. 1 | Limit |
| Polybrominated biphenyls | — | — | — | — | — |
| Monobromobiphenyl | mg/kg | With reference to US | 5 | N.D. | — |
| Dibromobiphenyl | (ppm) | EPA Method 3550C, | 5 | N.D. | — |
| Tribromobiphenyl | | analysis was screened | 5 | N.D. | — |
| Tetrabromobiphenyl | | via US EPA 3540C | 5 | N.D. | — |
| Pentabromobiphenyl | | with HPLC/DAD/MS | 5 | N.D. | — |
| Hexabromobiphenyl | | and performed by | 5 | N.D. | — |
| Heptabromobiphenyl | | GC/MS. | 5 | N.D. | — |
| Octabromobiphenyl | | | 5 | N.D. | — |
| Nonabromobiphenyl | | | 5 | N.D. | — |
| Decabromobiphenyl | | | 5 | N.D. | — |
| Total polybromobiphenyl (PBBs) | | | — | N.D. | 1000 |
| Polybromobiphenyl ethers | — | — | — | — | — |
| (PBBEs/PBDEs) | | | | | |
| Monobromobiphenyl ether | mg/kg | With reference to US | 5 | N.D. | — |
| Dibromobiphenyl ether | (ppm) | EPA Method 3550C, | 5 | N.D. | — |
| Tribromobiphenyl ether | | analysis was screened | 5 | N.D. | — |
| Tetrabromobiphenyl ether | | via US EPA 3540C | 5 | N.D. | — |
| Pentabromobiphenyl ether | | with HPLC/DAD/MS | 5 | N.D. | — |
| Hexabromobiphenyl ether | | and performed by | 5 | N.D. | — |
| Heptabromobiphenyl ether | | GC/MS. | 5 | N.D. | — |
| Octabromobiphenyl ether | | | 5 | N.D. | — |
| Nonabromobiphenyl ether | | | 5 | N.D. | — |
| Decabromobiphenyl ether | | | 5 | N.D. | — |
| Total polybromobiphenyl ether | | | — | N.D. | — |
| (PBBEs/PBDEs) | | | | | |
| Total of Mono- to Nona- | | | — | N.D. | 1000 |
| bromobiphenyl ether (Note 3) | | | | | |

Test part description:
No. 1: Silver-Green Filter
Note:
1. N.D. = Not Detected
2. “—” = Not Regulated
3. According to 2005/717/EC DecaBDE is exempt.

TABLE 18

| | | | Method | | |
|---|---|---|---|---|---|
| | | | Detection | Result | ROHS |
| Test item(s) | unit | Test method | Limit | NO. 1 | limit |
| hexavalent chromium | mg/kg (ppm) | With reference to US EPA | 2 | N.D. | 1000 |
| | | Method 3060A, analysis was | | | |
| | | performed by UV/Vis (US | | | |
| | | EPA 7196A). | | | |
| cadmium (Cd) | mg/kg (ppm) | With reference to EN1122 | 2 | N.D. | 100 |
| | | Method B: 2001, analysis | | | |
| | | was performed by ICP-AES. | | | |
| mercury (Hg) | mg/kg (ppm) | With reference to US EPA | 2 | N.D. | 1000 |
| | | 3052 Method, analysis was | | | |
| | | performed by ICP-AES. | | | |
| lead (Pb) | mg/kg (ppm) | With reference to US EPA | 2 | N.D. | 1000 |
| | | 3050 Method, analysis was | | | |
| | | performed by ICP-AES. | | | |

### IV. Conclusion

Therefore, with the above structure design, the present invention indeed has the following advantages and features:
1. The fiber of the shoe material of the present invention is mixed with functional particles so as to achieve the health care effects of bacterial killing, anti-bacteria, mildewproof, anti-mite, negative ion, far-infrared ray, flameproof, antistatic, anti-electromagnetic wave, deodorization, elimination of pollutant, e.g., TVOCs, PMx and so on, etc.
2. The shoe material of the present invention, when used as a shoe pad, has multi-layer structure, which makes the fiber have both mechanical property and better elasticity. When a fluid passes through the shoe material, vibration can be generated, thus activating the functional micro particles in the fibers to react vigorously to achieve effective health care function and also properly relax the foot.
3. The shoe material of the present invention, when used as shoe pad, is woven by fibers. It has better air ventilation and can be washed by water. Sanitation and health care can be ensured.
4. The shoe material of the present invention adds functional particles (such as submicron tourmaline). The mechanical strength of the shoe material thus produced is only slightly decreased.
5. The shoe material of the present invention adds functional particles (such as submicron tourmaline). The washing fastness experiment shows that the shoe material thus produced still holds predetermined functions.
6. The submicron tourmaline particle can efficiently enhance performance under electrostatic adhesion theory since the tourmaline is of negative electricity. The shoe material has better elasticity and friction. Since the water decomposes to be negative ions (H₃O²⁻) due to the special effect of thermal electricity and piezoelectricity, vibration frequency increases, friction force grows, a large amount of negative ions is released in dynamic model, so as to satisfy the standard requirement (1000-2000 ion/cc) for human health.
7. The present invention has microcapsule with essential oil. In order to avoid the essential oil from evaporating too soon, the essential oil is released at near fixed amount, so as to enhance the duration.
8. The shoe material of the present invention has predetermined antibacterial effect when nano silver particles are added therein.
9. The shoe material of the present invention is also flameproof. The safety of flameproof is secured.

What is claimed is:

1. A multi-function health care self-cleaning shoe material, comprising:
a shoe material main body, the main body including a peripheral contour area and an inner area; and
at least one sheet-form web body located in the inner area of the main body, the web body being fixed on the peripheral contour area, the web body being a web-form fabric having plural fibers in warp direction and plural fibers in weft direction, the fibers containing a plurality of functional particles therein.

2. The multi-function health care self-cleaning shoe material according to claim 1, wherein the inner area of the main body is formed by a plurality of web bodies laminated together.

3. The multi-function health care self-cleaning shoe material according to claim 2, wherein the inner area includes at least one dot-shaped or line segment-shaped bonding portion, the bonding portion being formed by the fibers of the plural web bodies that are bonded together.

4. The multi-function health care self-cleaning shoe material according to claim 1, wherein the shoe material main body is a shoe vamp.

5. The multi-function health care self-cleaning shoe material according to claim 1, wherein the shoe material main body is a shoe pad, the shoe pad including the peripheral contour area, the inner area, and the web body.

6. The multi-function health care self-cleaning shoe material according to claim 5, further comprising at least one cloth layer overlying the web body of the shoe pad, the friction coefficient of the cloth layer being higher than that of the web body.

7. The multi-function health care self-cleaning shoe material according to claim 6, wherein the cloth layer is bonded to the web body of the shoe pad by at least one dot-shaped or line segment-shaped bonding portion.

8. The multi-function health care self-cleaning shoe material according to claim 5, wherein the peripheral contour area of the shoe pad is a bonding layer of the fibers that are bonded together, the ends of the fibers being fixed by the bonding layer.

9. The multi-function health care self-cleaning shoe material according to claim 1, wherein the web body of the shoe material main body is weaved to have a plurality of three dimensional honeycomb structure array, each honeycomb structure being formed by plural fibers in warp direction arranged along a first arc face and plural fibers in weft direction arranged along a second arc face, wherein the first arc face intersects the second arc face.

10. The multi-function health care self-cleaning shoe material according to claim 1, wherein the shoe material main body is a shoe sole, the shoe sole including the peripheral contour area and the inner area.

11. The multi-function health care self-cleaning shoe material according to claim 10, wherein an arc-shaped belt is connected to the shoe sole for human's foot to wear in so as to form a slipper structure.

12. The multi-function health care self-cleaning shoe material according to claim 1, wherein the shoe material main body is a shoe pad or a shoe sole, and a plurality of reinforcements are provided on predetermined locations of the shoe pad or the shoe sole by pouring method.

13. The multi-function health care self-cleaning shoe material according to claim 12, wherein the material of the reinforcements is selected from at least one of the group consisting of PU, TPE, and EPA.

14. The multi-function health care self-cleaning shoe material according to claim 1, wherein the fiber is between 50 and 10000 Denier.

15. The multi-function health care self-cleaning shoe material according to claim 1, wherein the functional particle is selected from at least one of the group consisting of submicron tourmaline, titanium dioxide, nano bamboo carbon, zinc oxide, cupric oxide, ferric oxide, silica, tungsten oxide, manganese oxide, cobalt oxide, nickel oxide, nano silver particle, chitin, ferment, or nano noble metal, copper, zinc, aurum, platinum, palladium, niobium, microcapsule, enzyme, and photocatalyst.

16. The multi-function health care self-cleaning shoe material according to claim 15, wherein the microcapsule includes an internal storage space for storing natural essential oil selected from the group consisting of lavender, lemon, hinoki, rosemary, eucalyptus, tea tree, sandalwood, bergamot, pine, jasmine, rose, chamomile, Ylang Ylang, basil, geranium, niaouli, cardamom, musk, myrrh, cinnamon, fennel, frankincense, mandarin, citrus, peppermint, cedarwood, patchouli, palmarosa, clove, grapefruit, benzoin, ginger, citronella, and marjoram.

17. A manufacturing method for a shoe material, wherein the shoe material main body includes a peripheral contour area, an inner area, and at least one sheet-form web body located in the inner area of the main body, the web body being a web-form fabric having plural fibers in warp direction and plural fibers in weft direction, the fibers containing a plurality of functional particles therein, the manufacturing method comprising the steps of:
providing the at least one sheet-form web body;
forming at least one bonding line on the web body by bonding the fibers through an ultrasonic processing method, the bonding line serving as the peripheral contour area delimiting the inner area from the web body, the inner area defining the shape of the shoe material main body.

18. The manufacturing method according to claim 17, wherein the ultrasonic processing method utilizes an ultrasonic wave generation device, a top mold, and a first bottom mold,
placing the at least one web body between the top mold and the first bottom mold;
closing the top mold and the first bottom mold;
causing the top mold to have ultrasonic vibration through the ultrasonic wave generation device;
forming at least one bonding line on the web body by bonding the fibers through ultrasonic waves, the bonding line delimiting at least one of the inner area from the at least one web body; and
cutting along the bonding line by a trimming method to complete the production of the shoe material.

19. The manufacturing method according to claim 18, wherein the first bottom mold is further provided with at least one dot-shaped or line segment-shaped bump, the at least one web body comprises a plurality of web bodies laminated together, a dot-shaped or line segment-shaped bonding portion is formed on the inner area of the plural web bodies by the bump, and the bonding portion is formed by bonding the fibers of the plural web bodies.

20. The manufacturing method according to claim 18, further utilizing a second bottom mold, the second bottom mold being provided with a cutting edge having similar outline of the bonding line,
placing the web body between the top mold and the second bottom mold;
closing the top mold and the second bottom mold;
causing the top mold to have ultrasonic vibration through the ultrasonic wave generation device; and
cutting along the bonding line by the cutting edge of the bottom mold.

21. The manufacturing method according to claim 17, wherein the shoe material is selected from one of the group consisting of shoe vamp, shoe pad, and shoe sole.

22. The manufacturing method according to claim 17, wherein the functional particles is selected from at least one of the group consisting of submicron tourmaline, titanium dioxide, nano bamboo carbon, zinc oxide, cupric oxide, ferric oxide, silica, tungsten oxide, manganese oxide, cobalt oxide, nickel oxide, nano silver particle, chitin, ferment, or nano noble metal, copper, zinc, aurum, platinum, palladium, niobium, microcapsule, enzyme, and photocatalyst.

23. The manufacturing method according to claim 22, wherein the microcapsule has an internal storage space for storing natural plant extracted essential oil selected from at least one of the group consisting of lavender, lemon, hinoki, rosemary, eucalyptus, tea tree, sandalwood, bergamot, pine, jasmine, rose, chamomile, Ylang Ylang, basil, geranium, niaouli, cardamom, musk, myrrh, cinnamon, fennel, frankincense, mandarin, citrus, peppermint, cedarwood, patchouli, palmarosa, clove, grapefruit, benzoin, ginger, citronella, and marjoram.
